(19) United States
(12) Patent Application Publication
(10) Pub. No.: US 2015/0059954 A1
(43) Pub. Date: Mar. 5, 2015

(54) PNEUMATIC TIRE WITH COATED REINFORCEMENT

(71) Applicant: The Goodyear Tire & Rubber Company, Akron, OH (US)

(72) Inventors: Robert Edward Lionetti, Bereldange (LU); Olivier Marcel Eugene Durand, Domérat (FR); John Woods, Hanau Klein-Auheim (DE); Raphael Beck, Reichlange (LU)

(73) Assignee: The Goodyear Tire & Rubber Company, Akron, OH (US)

(21) Appl. No.: 14/010,732

(22) Filed: Aug. 27, 2013

(51) Int. Cl. B60C 9/00

(52) U.S. Cl. CPC B60C 9/0007; B60C 2009/0021
USPC 152/451; 152/556; 152/527; 152/539

(57) ABSTRACT

A pneumatic tire includes a pair of axially spaced apart annular bead structures, a carcass structure wrapped around each bead structure and having a pair of carcass turnups substantially contiguous with the carcass structure from the bead structure to radially outer ends of the pair of carcass turnups, a belt structure disposed radially outward of the carcass structure in a crown area of the pneumatic tire, an overlay structure disposed radially outward of the belt structure, and a component comprising a non-adhesive core structure and a coating applied to the core structure with the coating providing adhesion to a surrounding matrix for the core structure.

### FIELD OF THE INVENTION

The present invention relates to a pneumatic tire and, more specifically, to a reinforcement component of steel cords with a tackified coating.

### BACKGROUND OF THE INVENTION

A conventional pneumatic tire comprises a carcass ply having a main portion that extends between both bead cores of the tire and turnup portions that are anchored around each bead core. The conventional tire has radially outer edges of the turnup portions of the carcass ply disposed radially outwardly of the bead cores a minimal distance and are in contact with the main portion of the carcass ply. Suitable elastomeric materials surround the bead core, carcass ply, and other elastomeric components to complete the bead portion of the tire. A clamping member is comprised of a strip of side-by-side cords of a heat shrinkable material embedded in a suitable elastomeric substance having a permanent thermal shrinkage of at least 2 percent. This strip of cords extends from a location radially and axially inward of the bead core to a location radially outward of the bead core and there is no filler strip or apex disposed between the main portion and turnup portion of the carcass ply. The heat shrinkable material may be 1260/2 Nylon 6,6, having a permanent thermal shrinkage of about 4 percent. It is a continual goal in the tire art to simplify the construction and reduce the expense of building tires, yet improve the durability, handling, rolling resistance, and other properties of tires.

Another conventional pneumatic tire may have two carcass plies or a single carcass ply reinforced with metallic cords, respectively. Either conventional tire may have a high ending ply turnup and locked bead construction.

Still another pneumatic tire may have a single carcass ply 12 reinforced with parallel metallic cords, each cord composed of at least one filament having a tensile strength of at least (−2000×D+4400 MPa)×95%, where D is a filament diameter in millimeters. The turnup portion of the single carcass ply in the bead portion of the conventional pneumatic tire may be interposed between the bead core and a toe guard, with the radially outer edge of each turnup portion being in contact with the main portion of the carcass ply and extending to an end point 0.5 to 4.0 inches (12.7 to 101 6 mm) radially outward of the bead core. The toe guard may have a first end and a second end, each end disposed directly adjacent to the carcass ply.

The first end of the toe guard may be located on the axially inner side of the main portion of the carcass ply at a location about 0.4 to 3.5 inches (10 to 89 mm) radially outward of the bead core and the second end may be located at a point ranging from substantially the axially outermost point of the bead core to a location about 3.5 inches (89 mm) radially outward of the bead core. The first end and second end of the toe guard may be a shorter distance from the bead core than the end point of the turnup portion of the carcass ply.

The toe guard may be a rubber material, a flexible textile material, or a heat shrinkable material. For example, the toeguard may comprise a strip of side-by-side cords of a non-metallic heat shrinkable material which has a permanent thermal shrinkage of at least 2 percent wrapped circumferentially about the bead core and carcass ply turnup a plurality of times. When the toeguard is a rubber material, it may be canlendered gum strips circumferentially wound around the bead core and carcass ply turnups a plurality of times.

The use of separate stiffeners or apexes and chafer strips were shown to be used in combination with the plurality of windings of the gum strip used in the toeguard to form the bead portion of the tire. The uses of multiple windings of strip of material wound around the green or uncured tire to form a carcass in cylindrical form may lead to variations in the rubber thicknesses and gauges around the circumference of the tire as it is shaped toroidally and placed in a mold to cure under temperature and pressure.

Another conventional pneumatic tire includes a pair of axially spaced apart annular bead structures, a carcass structure wrapped around each bead structure and having a pair of carcass turnups substantially contiguous with the carcass structure from the bead structure to radially outer ends of the pair of carcass turnups, a belt structure disposed radially outward of the carcass structure in a crown area of the pneumatic tire, an overlay structure disposed radially outward of the belt structure, and a component comprising a non-adhesive core cord and a wrap cord encircling the core cord with the wrap cord providing adhesion to a surrounding matrix for the reinforcement cord.

### SUMMARY OF THE PRESENT INVENTION

A pneumatic tire in accordance with the present invention includes a pair of axially spaced apart annular bead structures, a carcass structure wrapped around each bead structure and having a pair of carcass turnups substantially contiguous with the carcass structure from the bead structure to radially outer ends of the pair of carcass turnups, a belt structure disposed radially outward of the carcass structure in a crown area of the pneumatic tire, an overlay structure disposed radially outward of the belt structure, and a component comprising a non-adhesive core structure and a coating applied to the core structure with the coating providing adhesion to a surrounding matrix for the core structure .

According to another aspect of the present invention, the carcass structure includes the component.

According to still another aspect of the present invention, the belt structure includes the component.

According to yet another aspect of the present invention, the overlay structure includes the component.

According to still another aspect of the present invention, the bead structures include the component.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load. “Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); and 5) a narrow strip of material with or without twist.

### BRIEF DESCRIPTION OF THE DRAWINGS

The invention will be described by way of example and with reference to the accompanying drawings in which:

FIG. 1 is one half of a schematic cross-sectional view of an example tire in accordance with the present invention.

FIG. 2 is a schematic cross-sectional view of an example cord construction in accordance with the present invention.

### DETAILED DESCRIPTION OF AN EXAMPLE OF THE PRESENT INVENTION

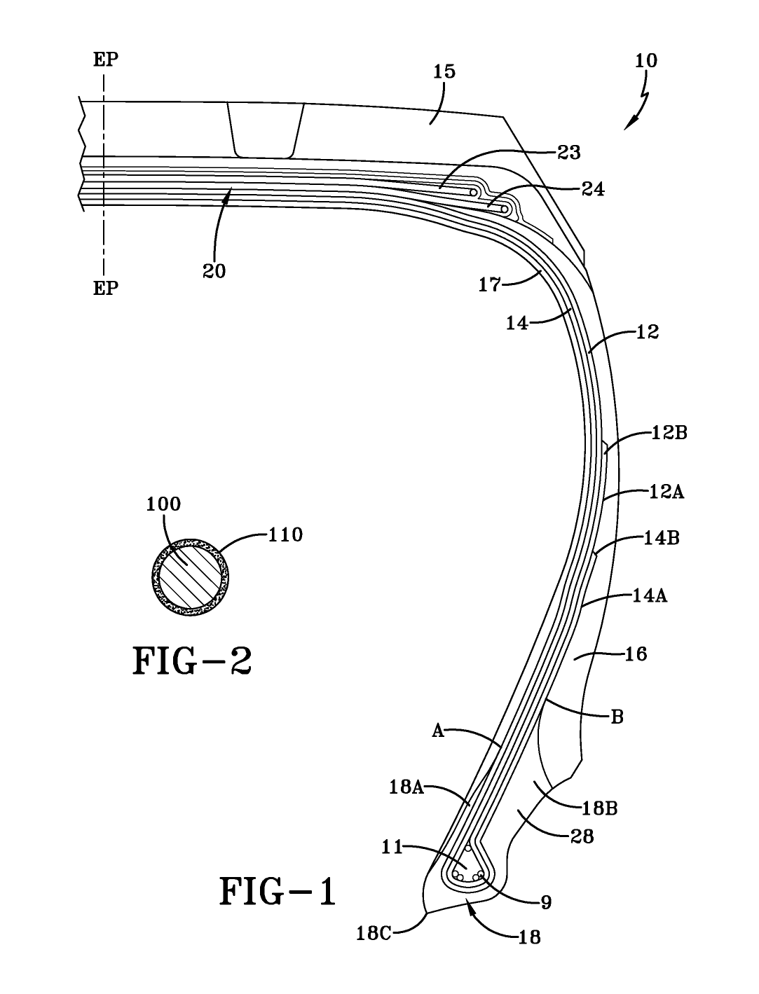

FIG. 1 shows a cross-sectional view of an example tire 10 in accordance with the present invention. The example tire 10 may have a pair of bead structures 11 each having a core, each comprising a plurality of metallic filaments. The example tire 10 may be characterized by a first carcass ply 12 and a second carcass ply 14 that extend between the bead cores 11 and turnup portions 12a, 14a anchored around each bead core 11. A belt structure 20 may have at least two belts 23, 24 disposed radially outward of the main portion of the carcass plies 12, 14 and a ground engaging tread portion 15 may be disposed radially outward of the belt structure 20. An overlay ply 25 may be disposed radially outward of the belt structure 20. The bead structures 11 may further include a chafer, a toeguard, a chipper, and/or a flipper.

Sidewall portions 16 may extend radially inward from the tread portion 15 to the bead cores 11. On the axially inner side of the carcass ply 14, an innerliner 17 may be used. The innerliner 17 may consist of a layer or layers of elastomer or other material that form an inside surface of the tire 10 for containing inflation fluid, such as air, within the tire. Additional barriers, reinforcement strips, and/or gum strips (not shown) may be disposed at suitable locations between the innerliner 17 and the main portion of the carcass ply 14 to avoid penetration of rubber through the carcass ply 14 during curing.

The belt structure 20 may comprise a plurality of belt plies 23, 24 located radially outward of the carcass plies 12, 14 in a crown portion of the tire 10. The elastomeric tread portion 15 may be disposed radially outward of the belt structure 20. The belt structure 20 may have at least two annular layers or plies 23, 24 of parallel cords, woven or unwoven, underlying the tread portion 15, unanchored to the bead cores 11. The belt structure 20 may have both left and right cord angles in the range from 40 to 15 degrees with respect to an equatorial plane EP of the tire 10. The belt structure 20 illustrated in FIG. 1 and described herein may be an example. For example, in those instances where a larger tire is being constructed for use in a radial light truck application, three or more belts may be used. In addition, cords in the belt plies 23, 24 may be rayon, polyester, glass fiber, aramid, steel wire, and/or the like. The cords may be steel wire filaments having a tensile strength of at least (−1400×D+4050)×95% when D is the filament diameter in millimeters. Further, the cords may be composed of at least one filament having a tensile strength of at least (−2000×D+4050)×95% when D is as defined above.

The bead cores 11 may each comprise a plurality of wraps of a single metallic filament 9. Each of the bead cores 11 may have a circumferential cross-sectional shape, which may be substantially triangular, pentagonal, hexagonal, rectangular, or circular. The metallic filament 9 used in the bead cores 11 may be, for example, a 0.05 inch (1.27 mm) diameter steel wire coated with bronze to enhance its bonding with rubber. Other filament diameters may also be used.

The cords of the carcass plies 12, 14 may intersect the equatorial plane (EP) of the tire 10 at an angle in the range from 75 to 105 degrees. Further, the cords may intersect at an angle of 82 to 98 degrees or 89 to 91 degrees.

The carcass plies 12, 14 and a toe guard 18 may be folded about each bead core 11. The radially outer edge of each turnup portion 12a, 14a may be in contact with the main portion of the carcass plies 12, 14 and may extend to an end point 12b, 14b 0.5 inches (12.7 mm) to 4.0 inches (101.6 mm) radially outward of each bead core 11 from the middle of each bead core. The turnup portions 12a, 14a may extend to an end point 12b, 14b 0.5 inches (12.7 mm) to 3.5 inches (88.9 mm) radially outward of each bead core 11. End point 12b may be radially inward (not shown) or radially outward (FIG. 1) of end point 14b. Locking in of the bead cores 11 may be achieved by adhesion between the turnup portions 12a, 14a and the main portion of the carcass plies 12, 14.

Each toe guard 18 may have a first-end 18a and a second end 18b. Each end 18a, 18b may be disposed directly adjacent to the carcass ply 14. The first end 18a may be located on the axially inner side of the main portion of the carcass ply 14 at a location about 0.4 inches (10 mm) to 3.5 inches (89 mm) radially outward of the bead core 11 from substantially the middle of the bead core. Further, the first end 18a may be located on the axially inner side of the main portion of the carcass ply 14 at a location A about 0.4 inches (10.16 mm) to 2.0 inches (50.8 mm) radially outward of the bead core 11. The second end 18b of the toe guard 18 may be located at a point B ranging from the axially outermost point of the bead core 11 to a location about 3.5 inches (89 mm) radially outward of the bead core from the middle of the bead core. Further, the second end 18b of the toe guard 18 may be located at a point B ranging from the axially outermost point of the bead core 11 to a location B about 2.0 inches (50.8 mm) radially outward of the bead core 11.

The carcass ply turnups 12a, 14a may be folded about the bead core 11 and locked against the main portion of the carcass ply 12 by the sidewall 16. The wrap-around toeguard 18 may be made of a single elastomeric material or composition 28.

As described above, conventional passenger/SUV tires may have a casing/carcass construction that uses two layers of “ply treatment” (e.g., fabric cords embedded in a rubber matrix). Conventional tires typically may use the same denier (cord weight) of a specific type of polyester cord for both layers. For example, a conventional tire may use polyester cord with a denier of 1500 in both ply layers.

One example ply 12 or 14 may use higher denier polyester cords (e.g., 1500, 2000) and the other example ply 14 or 12 may use lower denier polyester cords (e.g., 1000, 1500). The benefits of such a two ply construction may include a reduction in tire weight, a reduction in tire/material cost, a reduction in rolling resistance force, improved tuning of noise-vibration-handling (NVH) performance characteristics, and lower heat generation in the casing structure leading to improved durability and high-speed performance characteristics.

In general, either ply 12, 14 may have a cord with a construction of 900-2500 denier/2 polyester with 7-15/7-15 turns per inch (tpi) and 20-35 end per inch (epi). Specifically, the radially outer carcass ply 12 may have a cord with a construction of 900-1100 denier/2 polyester with 11-13/11-13 tpi and 14-20 epi; and the radially inner carcass ply 14 may have a cord 110 with a construction of 1400-1600 denier/2 polyester with 8-10/8-10 tpi and 14-20 epi.

An uncoated cord, such as uncoated steelcord, bead wire, or any reinforcement cord structure, may have no tack and may not adequately stick to a rubber compound when applied. Wrapping the uncoated cord 100 with one or more tackified cords 110 (e.g., two, three, four, five, etc.) may exhibit the necessary tack thereby maintaining its position when applied to a rubber compound, such as at a tire building machine.

In accordance with the present invention, any component in a pneumatic tire, such as the carcass plies 12, 14, bead structures 11, belt plies 23, 24, overlays 25, apexes, chippers, flippers, sidewall inserts, toeguards 18, crown portion 15, etc., may utilize a raw or non-adhesive reinforcement cord structure 100 with a adhesive coating component 110 for enhancing adhesion to the surrounding rubber or polymer matrix (FIG. 2). Such a construction may include twisted steel filaments/cords 100 and a tackified coating 110. The tackified/adhesive coating 110 may be an adhesive applied to (e.g., dipped, sprayed, plasma polymerized, ion deposited, etc.) the surface of the cord 100 enabling subsequent adhesion to a green/uncured compound matrix.

Conventional steel reinforcements may be coated with rubber through an extrusion or calendering operation before being used to assemble a pneumatic tire. These processes may fix the reinforcement density and orientation to match the desired tire design characteristics in a green, or uncured, treatment. This treatment may then be used to assemble the reinforced components of the pneumatic tire during tire building.

Further, a cord construction 100, 110 in accordance with the present invention may also be directly applied to other rubber components and hold the desired density and orientation. For example, after a layer of coat compound is applied at a building drum, the cord construction 100, 110 may be applied at the desired orientation and density and another coating layer may be applied. Stock preparation steps, such as calendering and extrusion of rubber compound to the wire, may thereby be eliminated. The amount of compound required to coat the cords for adhesion may also be reduced.

As stated above, a component, such as a carcass ply 12, 14, bead structure 11, belt ply 23, 24, overlay 25, apex, chipper, flipper, sidewall insert, toeguard 18, crown portion 15, etc., in accordance with the present invention may produce excellent adhesion leading to enhanced cost, weight, and performance characteristics in a pneumatic tire 10. This component thus enhances the performance of the tire pneumatic 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). Important structural elements are the carcass, belt and bead structures, typically made up of many cords of materials, embedded in, and bonded to, a matrix of low modulus polymeric material, usually natural or synthetic rubber. Id. at 207 through 208.

The carcass or belt cords may be disposed as a double layer. Id. at 208. Tire manufacturers throughout the industry cannot agree or predict the effect of different twists of cords of the carcass structure on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREAD WEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, the cord characteristics affect the other components of a pneumatic tire (i.e., carcass structure affects apex, belt ply, overlay, etc.), leading to a number of components interrelating and interacting in such a way as to affect a group of functional properties (noise, handling, durability, comfort, high speed, and mass), resulting in a completely unpredictable and complex composite. Thus, changing even one component may lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventor.

Thus, for example, when the structure (i.e., twist, cord construction, etc.) of a component of a pneumatic tire is modified with the intent to improve one functional property of the pneumatic tire, any number of other functional properties may be unacceptably degraded. Furthermore, the interaction between the components may also unacceptably affect the functional properties of the pneumatic tire. A modification of any component may not even improve that one functional property because of these complex interrelationships.

Thus, as stated above, the complexity of the interrelationships of the multiple components makes the actual result of modification of a component in accordance with the present invention, impossible to predict or foresee from the infinite possible results. Only through extensive experimentation has the cord structure 100, 110 of the present invention been revealed as an excellent, albeit unexpected and unpredictable, option for a pneumatic tire.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A pneumatic tire comprising:
a pair of axially spaced apart annular bead structures;
a carcass structure wrapped around each bead structure and having a pair of carcass turnups substantially contiguous with the carcass structure from the bead structure to radially outer ends of the pair of carcass turnups;
a belt structure disposed radially outwardly of the carcass structure in a crown area of the pneumatic tire;
an overlay structure disposed radially outward of the belt structure; and
a component comprising a non-adhesive core structure and a coating applied to the core structure with the coating providing adhesion to a surrounding matrix for the core structure.

2. The pneumatic tire as set forth in claim 1 wherein the carcass structure includes the component.

3. The pneumatic tire as set forth in claim 1 wherein the belt structure includes the component.

4. The pneumatic tire as set forth in claim 1 wherein the overlay structure includes the component.

5. The pneumatic tire as set forth in claim 1 wherein the bead structures include the component.

6. The pneumatic tire as set forth in claim 1 wherein the core structure includes two steel cords.

7. The pneumatic tire as set forth in claim 1 wherein the core structure includes three steel cords.
